(19) United States
(12) Patent Application Publication
(10) Pub. No.: US 2007/0168628 A1
(43) Pub. Date: Jul. 19, 2007

(54) Method for backing up personal data of a telecommunications network subscriber, server and associated device

(75) Inventors: Christophe Martin, Ceyreste (FR); Stephane Schirar, La Bouilladisse (FR)

Correspondence Address: BUCHANAN, INGERSOLL & ROONEY PC, POST OFFICE BOX 1404, ALEXANDRIA, VA, 22313-1404, US

(73) Assignee: GEMPLUS, GEMENOS FRANCE (FR)

(21) Appl. No.: 10/583,476

(22) PCT Filed: Dec. 15, 2004
(86) PCT No.: PCT/EP04/53507

§ 371 Date: Jun. 19, 2006

(30) Foreign Application Priority Data
Dec. 19, 2003 (FR) 03/51130

(51) Int. Cl. G06F 12/16

(52) U.S. Cl. 711/162

(57) ABSTRACT

In a method for backing up personal data of a wireless communications network subscriber, the data is saved in a mobile communications device and backed up in a server of the network. A first subset of data is prepared from a set to be saved by a SIM card and is transmitted to the server for backing up. In an asynchronous backup mode, after the transmission of a subset of data to be backed up on the server, the backup is delayed for a certain period of time in order to free the mobile device for the user, and the backup is resumed at the end of this period.

The invention relates to the field of wireless communication networks and, more specifically, to a method of backing up a personal information file, such as a phone book saved in the mobile devices that use these networks or the associated subscriber identity module cards.

In such a network, such as a GSM network (acronym meaning Global System for Mobile Communication), subscribers have a SIM card (SIM is an acronym meaning Subscriber Identity Module). This SIM card is personalised so as to allow the subscriber to have access to various applications and/or services. It also contains personal information, such as files of phone books, diaries, etc.

Operators currently allow their subscribers to back up this personal information onto a server by means of a telecommunications system on the network, such as SMS (acronym meaning Short Message Service).

Most technical solutions rely on a mechanism for synchronising data memorised in the card and/or mobile with the data memorised in a backup database of the server. In this mechanism, only the modified data are transferred with a view to optimising the use of SMS due to the cost involved.

The current mechanism has the disadvantage of requiring all the information to be transferred during the initial synchronisation or update, since the network detects changes in all the data. For this reason, the subscriber must wait a relatively long time for the initial synchronisation operation to be completed before he/she can use his/her mobile.

The waiting time for backing up a phone book containing 255 telephone numbers with names associated is estimated at 5 minutes.

The backup can be started manually at the request of the user and still require the mobile to become unavailable for the user for a long period of time.

One aim of this invention is to find a mechanism for backing up subscriber data onto a telecommunications network server which has none of the mentioned disadvantages, the data being contained in the card and/or in the mobile.

For this purpose, the invention relates to a method of backing up personal data of a wireless communication network subscriber, the data being memorised in a mobile communication device and backed up onto a network server, in which a first subset of data is prepared from among a batch of data to be backed up, and is transmitted to the server for backing up.

It is characterised in that it comprises a so-called asynchronous backup mode according to which, once a subset has been transmitted to the server, the backup is delayed by a certain period of time so as to free the mobile for the user, and the backup is resumed at the end of this period.

According to other characteristics of the method:
the server or the mobile implement a countdown of the period and transmit a resume signal to the card at the end of the period;
the mobile implements the countdown and transmits the resume signal following an instruction from the card;
the method comprises a prior step according to which it determines whether the volume of data to be saved or the waiting time required for making the mobile available to the user is higher than a predetermined threshold and, if this is the case, the backup is performed using the asynchronous mode and, if not, the backup is performed using a default mode.

The invention further relates to a server for backing up personal data of a wireless communication network subscriber, the data having been previously memorised in a mobile communication device or an associated card, said server being able to back up a first subset of data from among a batch to be backed up.

It is characterised in that it comprises a so-called asynchronous “server” backup program that can perform the following functions:
receiving and saving a first subset of data and placing it in waiting mode according to a delay instruction,
and, at the end of the delay instruction, resuming the backup of subsequent data subsets.

The invention further relates to a portable wireless communication device belonging to a subscriber of a communication network, containing data memorised in a backup application that can transmit a first subset of data from among a batch of data to be backed up to a server for backing up.

It is characterised in that the application in the device can:
delay by a given period of time the backup of a subset of data that is subsequent to the first subset so as to ensure that the user can use the device,
and resume the backup at the end of the period.

The device according to the invention includes all wireless communication devices (mobile) that are portable, such as PDAs, personal assistants with a wireless communication function, and that work with or without a chip card, as well as a chip card.

Further characteristics and advantages of the invention will appear from reading the following description of specific embodiments of the invention, said description being provided with the appended drawings, in which:

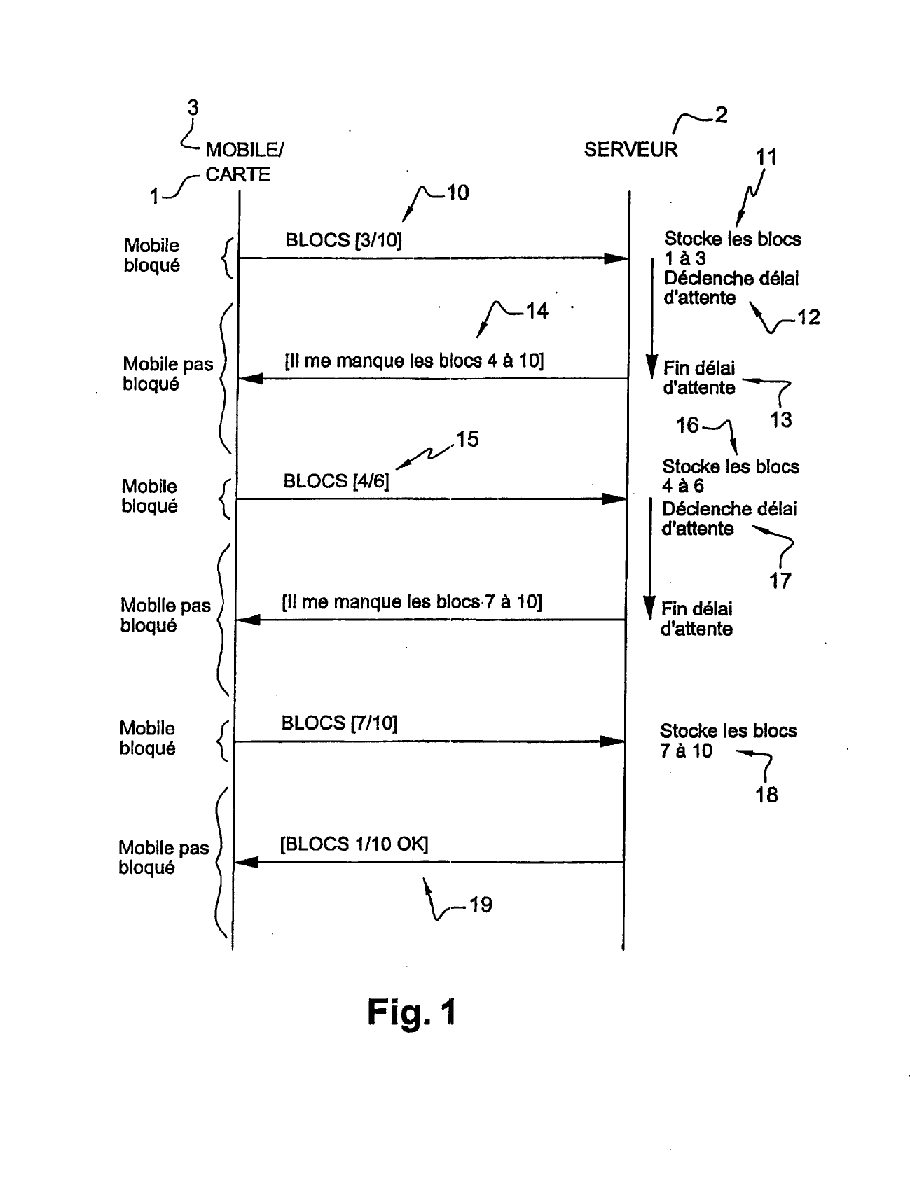

FIG. 1 is a diagram showing the method of the invention according to a first embodiment thereof,

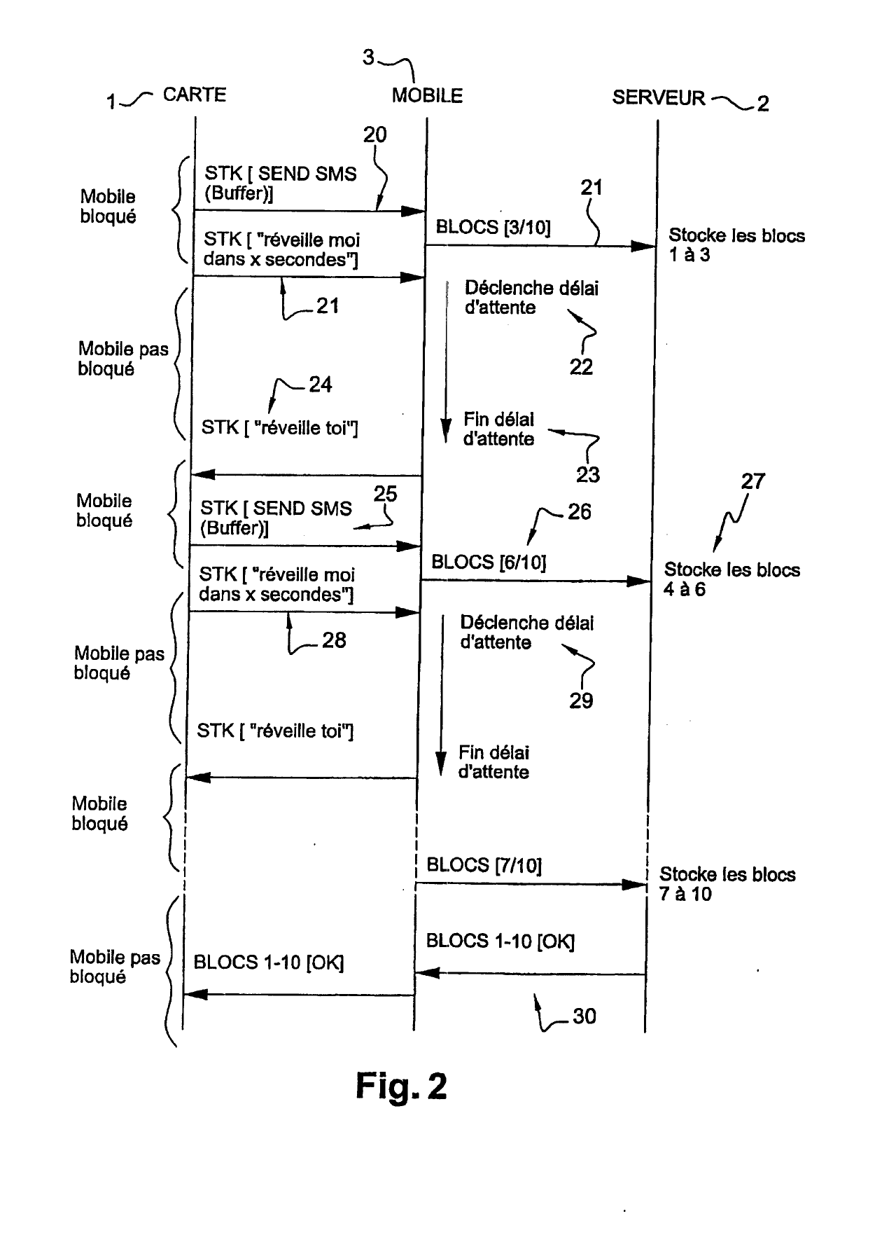

FIG. 2 is a diagram showing the method of the invention according to a second embodiment thereof,

FIG. 3 is a diagram showing the method of the invention according to a third embodiment thereof,

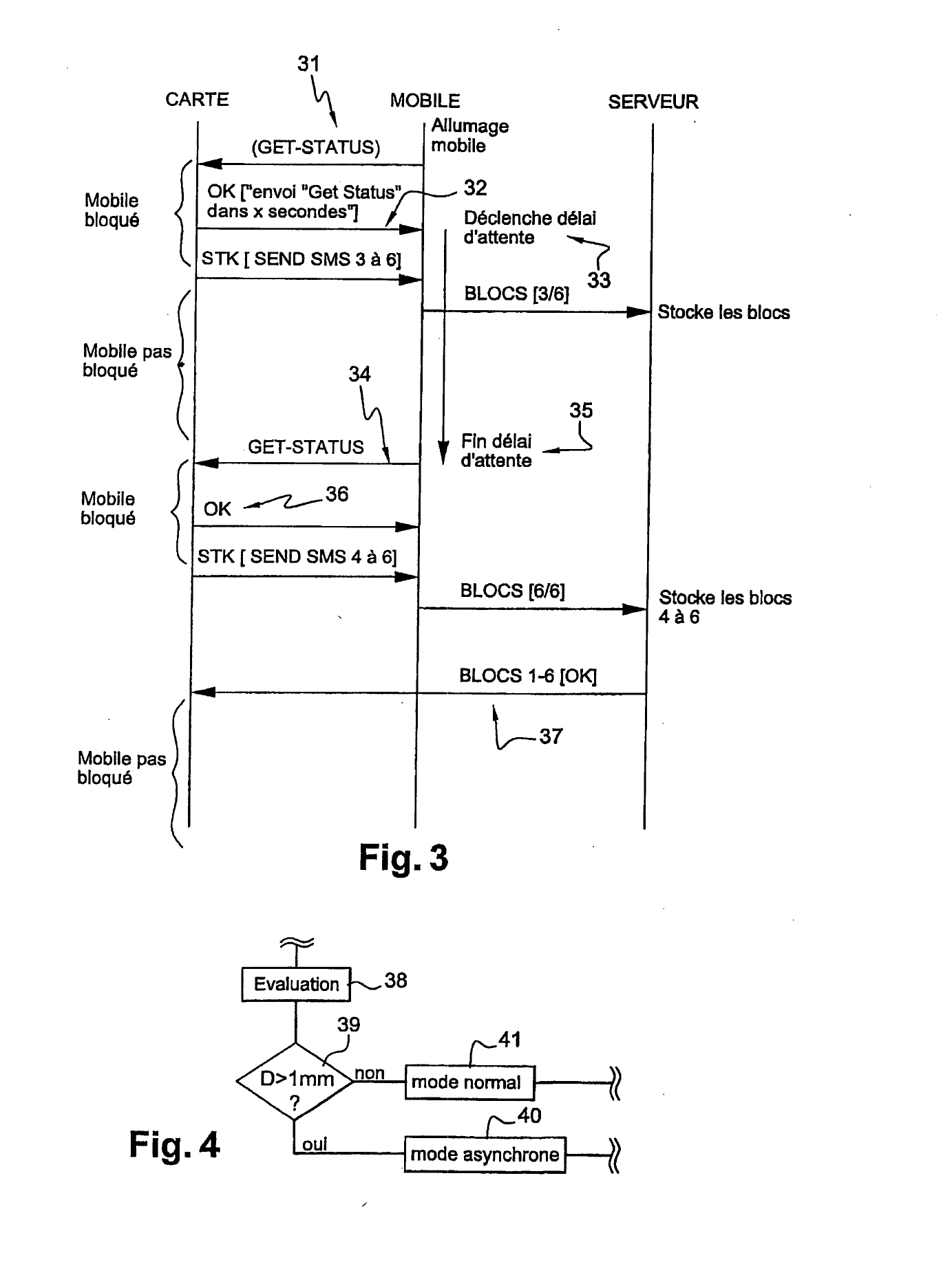

FIG. 4 is a diagram showing a step of a data backup routine that completes the invention.

In the example, a wireless communication architecture is used for a GSM network comprising mobiles of subscribers equipped with a SIM card 1 and a remote server 2 that can be accessed by so-called SMS messages. The mobiles 3 can include other communication devices such as PDAs, personal assistants equipped with a wireless communication interface.

The data can be saved previously in the mobile device and/or in the card. In the example, the data are initially in the card.

The server contains a communication interface for receiving and sending messages with the mobiles, as well as a database for backing up the personal data of the subscribers.

The server also includes, in a processing unit, a “server” backup application (exclusive to the server) that can perform various functions which will be developed subsequently according to the variants of the invention.

This program implements at least one function of receiving at least one SMS message containing a first block of personal data and of saving this block.

According to a preferred variant, the program can implement a delay instruction. This instruction can be included in the server program or received in an SMS message created by the card and/or the mobile.

The server backup program, for example, can include a step of starting a clock and, at the end of the requested waiting time, resuming the backup process. To do so, it can create and send a message to resume the backup of the subsequent blocks to the mobile and/or the card.

On the other hand, the portable wireless communication device is a mobile comprising a SIM card. In the example, the chip of the card contains memorised personal data and a card-specific backup application. This program is able, in a known fashion, to transmit to the server for backup at least one first subset of data from among the batch of data to be backed up.

The data, however, can be previously saved in the mobile device and/or in the card.

According to a variant of the invention, the card application can also be programmed to space out the backup of the various subsets or blocks of data over a given period of time, so as to make sure the device can be used by the subscriber between two backups of blocks of data.

The backup program of the card preferably contains several backup modes that can be selected by the user, in particular a normal backup mode 41 and the asynchronous mode 40 according to the invention. The modes can also be selected automatically as explained below.

The method of the invention is described initially in relation with FIG. 1 according to the preferred mode.

At the request of the user or at regular intervals, a known data backup process is carried out. According to this process, the data to be backed up are broken down into a number n of subsets or blocks and are then sent by means of n SMS messages, each containing at least one block, an indication of the number of blocks to be sent and an indication of the order of the blocks or of how to chain them together.

In the example, the card has 10 telephone numbers and addresses to be backed up, forming 10 blocks. Initially, the card defines 3 subsets and prepares to send a subset containing 3 blocks, which it places in its buffer. To do so, it requests the mobile to transmit the contents of the buffer to the server via an SMS message, and the mobile complies in step 10.

The server receives and saves, in step 11, the subset in its database. By virtue of the server backup application mentioned previously, the invention makes it possible to delay the backup by a certain period of time.

Meanwhile, the card stops sending the subsequent block and leaves the mobile free, thus ensuring that the normal functions of the mobile are available.

On the other hand, the server implements a countdown of the delay 12 according to the program it contains for this purpose. For this countdown, the processing unit of the server performs one step of the program that consists of starting a clock and, when a given time has elapsed 13, 2 minutes for example, it sends a resume signal to the card. In the example, the server sends a message 14 stating that it is missing the subsequent blocks (blocks 4-10). The server can also implement any other equivalent means of spacing out the backups, such as timetables, regular or random periods, etc.

The message received by the card through the mobile “awakens” the card, in the sense that it is interpreted by the card's backup application as a signal to resume the backup.

In response to this message, the card's backup application prepares the following 3 blocks (4-6) and sends them (step 15) via the mobile as an SMS message.

The following blocks are received and saved 16 as above and the application starts to count down a new delay 17 and so on.

Once the last blocks have been sent and saved 18, the server sends an acknowledgement of receipt “OK” message 19 and the backup ends without having immobilised the user's mobile for any long, continuous period of time.

A variant of this embodiment of the invention is shown in FIG. 2.

After transmitting 20, 21 a subset of blocks 3-10 to the server, using an STK (SIM toolkit) command sent by the card to the mobile, the card's backup application “stops the backup” and sends another STK command in which the card requests the mobile to count down a delay and to “awaken” the card at the end of said delay 21.

The mobile then implements 22 a clock and, after the set time 23, sends a wake-up signal to the card 24 via an STK command. In response, the backup application in the card prepares a second block of data (6-10) and sends it to the mobile by means of an STK command for it to be sent to the server.

Then, as explained above, the card requests the mobile to wake up after X seconds (step 28), which is effectively followed by starting another delay countdown 29 in the mobile, and so on.

On the other hand, the server follows the received instructions 27 to back up the various blocks received and, when it identifies the last block, sends an acknowledgement of receipt “OK” message (step 30).

In a third variant shown in FIG. 3, the “GET STATUS” instruction that exists in certain mobiles is diverted so as to implement the method and, specifically, to awaken the card or, in other words, as a signal to resume the backup.

This instruction is generally used by the mobile when it is switched on and regularly after that so that the mobile can check that the card is in place and that everything is in order.

When the card receives this instruction 31, the card's application sends an OK reply and takes the opportunity to add an instruction 32 asking the mobile to reissue the next “GET STATUS” instruction after a certain delay or at a given time.

The mobile, following the instructions of the card, starts to count down the delay 33 and transmits the “GET STATUS” signal 34 at the end of said delay (step 35).

The backup of the subsequent blocks of data (4-6) will be carried out as a response to the next “GET STATUS” instruction received, and so on until all the blocks have been sent and an acknowledgement of receipt message 37 is received from the server the same as above.

In each alternative embodiment of the invention, the card's backup application can include a routine that calculates the discounted backup time 38 according to the volume of data to be backed up in normal mode.

The card application can also include a test step 39, which enables automatic switching between backup modes. If the waiting time is higher than a predetermined threshold, for example 1 minute, the backup is performed in asynchronous mode 40 according to the invention. If the waiting time is lower than the threshold, the backup is performed according to the normal mode 41 by default. The test can also apply to a volume of data that corresponds to the waiting time, and the threshold can be expressed as a volume of data.

The application can also allow the user to choose one of the two modes by displaying a message on the screen, and obtaining validation for one mode or the other.

With each request for agreement, the message can be sent together with an indication of the estimated time for the backup according to each mode.

1. Method of backing up personal data of a wireless communication network subscriber, the data being memorised in a mobile communication device and backed up in a network server, in which a first subset of data is prepared from among a batch of data to be backed up and is transmitted to the server for backing up,
wherein said method includes an asynchronous backup mode in which, once a subset has been transmitted to the server, the backup is delayed by a certain period of time so as to free the mobile device for the user, and the backup is resumed at the end of this period.

2. Method according to claim 1, wherein, in order to resume the backup, the server implements a countdown of the period and sends a resume signal to a chip card in the mobile device at the end of said period.

3. Method according to claim 1, wherein, in order to resume the backup, the mobile device implements a countdown of the period and sends a resume signal to a chip card in the mobile device at the end of said period.

4. Method according to claim 3, wherein the mobile implements the countdown and sends the resume signal upon receiving an instruction from the chip card.

5. Method according to claim 4, wherein the chip card gives instructions to the mobile device by means of STK commands.

6. Method according to claim 4, wherein the chip card gives instructions by means of “GET STATUS” commands.

7. Method according to claim 1, further comprising a prior assessment step which determines whether the volume of data to be backed up or the corresponding waiting time required to make the mobile device available to the user is higher than a predetermined threshold,
if so, the backup is performed according to the asynchronous backup mode
and if not, the backup is carried out according to a default mode.

8. Server for backing up personal data of a wireless communication network subscriber, the data having been previously memorised in a mobile communication device, said server being able to back up a first subset of data from among a batch of data to be backed up,
said server including an asynchronous server backup program that can implement the following functions:
receiving and saving a subset of data and entering a waiting mode according to a delay instruction, p1 and, at the end of the delay instruction, resuming the backup of subsequent subsets of data.

9. Portable wireless communication device belonging to a communication network subscriber, comprising memorised data and a “device” backup application that can transmit a first subset of data from among a batch of data to be backed up to the server for backing up,
wherein the device application can, according to an asynchronous backup mode:
delay by a given period of time the backup of a subset of data that is subsequent to the first subset, so as to ensure that the user can use the device,
and resume the backup at the end of the period.

10. Portable device according to claim 9, wherein said device selectively operates according to an asynchronous backup mode 40 and a normal mode.
